(19) United States
(12) Patent Application Publication
(10) Pub. No.: US 2017/0336635 A1
(43) Pub. Date: Nov. 23, 2017

(54) IMAGING DATA CAPTURE AND VIDEO STREAMING SYSTEM

(71) Applicant: MAYO FOUNDATION FOR MEDICAL EDUCATION AND RESEARCH, Rochester, MN (US)

(72) Inventors: Jangwon Yoon, Jacksonville, FL (US); Robert Chen, Atlanta, GA (US); Phillip Han, Atlanta, GA (US); Phong Su SI, Martinez, GA (US)

(21) Appl. No.: 15/520,141

(22) PCT Filed: Oct. 20, 2015
(86) PCT No.: PCT/US15/56339

§ 371 Date: Apr. 19, 2017

Related U.S. Application Data
(60) Provisional application No. 62/066,146, filed on Oct. 20, 2014.

(51) Int. Cl. G02B 27/01; H04N 21/2347; H04N 21/422; H04N 21/4363; H04N 21/4223

(52) U.S. Cl. CPC G02B 27/0172; H04N 21/43637; H04N 21/4223; H04N 21/42203; H04N 21/2347; G02B 2027/0178; G02B 2027/014; G02B 2027/0138; G02B 2027/0123

(57) ABSTRACT

Systems and methods of the present invention provide for one or more server computers communicatively coupled to a network and configured to: receive an imaging data from a medical imaging device; encode a digital video data stream from the video data; transmit the digital video data stream via a wireless channel to at least one terminal output device coupled to the network, the terminal output device comprising: a camera mounted to the terminal output device comprising a lens transmitting, to the terminal output device, a view of a surgical field; and a display attached to the terminal output device and displaying the digital video data stream concurrently with the view of the surgical field.

### CROSS REFERENCE TO RELATED APPLICATIONS

This application is based on, claims priority to, and incorporates herein by reference, U.S. Provisional Patent Application No. 62/066,146, filed on Oct. 20, 2014, and entitled “System and Method for Viewing of Medical Images.”

### BACKGROUND OF THE INVENTION

The present invention disclosure provides systems and methods related to medical imaging systems such as Magnetic Resonance Imaging (MRI) or Computerized Tomography (CT) systems, endoscopic or laparoscopic devices, and the like. More particularly, the present disclosure relates to the capture of data generated by these medical imaging devices, and streaming this data onto a terminal output device, such as smart display systems.

Currently, medical imaging systems in the operating room rely on devices such as endoscopes, laparoscopic devices, and navigation systems (e.g., Brainlab or Stealth) that are generated and displayed as images on one or more monitors so that the surgeons can review these images during surgery. The monitors may be bulky, thereby requiring significant space in the operating room. The monitors must be positioned within the surgeon's field of view, so that surgeons and operating room staff are able to see the imaging data (e.g., MRI images) displayed on the screen. This approach requires that surgeons look away from the field of surgery to view the displayed imaging data.

From a cost perspective, not only do such monitors increase the overall healthcare cost to the hospital in the form of equipment, but a monitor-based approach adds to the operating room time, and therefore the overall cost of the procedure, since the doctor is required to divide his attention between the field of surgery and the captured image on the medical imaging monitor. In a study published in 2005, the average cost of a minute in the operating room was calculated to be $62 ($22 to $133/minute). Thus, for each additional minute the surgeon has to shift attention between the field of surgery and the captured image on the medical imaging monitor, the greater the cost of the surgical procedure.

During some surgical procedures, the surgeon may also use a microscope and/or surgical loupe for a more detailed view of the surgical procedure. A problem with either of these tools is that the surgeon's view, possibly including the view of the surrounding tissue, is limited, and medical instruments may be completely outside the scope of the surgeon's view. For example, if the surgeon is zoomed in on an extremely small area of an incision, each movement of an instrument will appear relatively large, if seen at all. In addition, tools such as microscopes and surgical loupes may act as a barrier, hindering the standing position of the surgeon and the movement of the surgeon's hands. There is therefore a need for improved systems and methods for operating room guidance and inter-operative feedback systems.

The interconnected medical imaging capture and stream system disclosed herein relays medical imaging results from MRI, CT and endoscopy onto a wearable heads-up display worn by a surgeon during a procedure in the operating room. This heads-up display may comprise smart display glasses that displays the medical imaging data from the medical imaging systems, thereby allowing the surgeon to look directly at the tissue in vivo through the smart display glasses.

This approach provides several advantages. First, the cost of imaging data monitors is eliminated. In addition, the wearable heads-up display allows the surgeon to see the transmitted medical images in addition to the surgical field in real time, thereby reducing the total amount of time for the surgery, since the surgeon would no longer be required to shift his focus between the field of surgery and the monitors displaying the data.

This approach also eliminates the need (and cost) for microscopes or surgical loupes. The wearable heads-up display creates a more efficient environment for the surgeon, allowing the surgeon to zoom in and out of the field of surgery, giving them better depth perception and overall view of the surgical field and instruments used. The disclosed invention may also include additional software accessible via the wearable electronic mobile device, and this software, or the commands within it, may be accessible via voice commands. In embodiments utilizing navigation tools or systems, the heads up display may also work as both a microsurgical tool and a navigation tool. The smart display glasses may also comprise radio-protective glasses.

### SUMMARY

Systems and methods of the present invention provide for one or more server computers communicatively coupled to a network and configured to: receive an imaging data from a medical imaging device; encode a digital video data stream from the video data; transmit the digital video data stream via a wireless channel to at least one terminal output device coupled to the network, the terminal output device comprising: a camera mounted to the terminal output device comprising a lens transmitting, to the terminal output device, a view of a surgical field; and a display attached to the terminal output device and displaying the digital video data stream concurrently with the view of the surgical field.

### BRIEF DESCRIPTION OF THE DRAWINGS

FIG. 1 illustrates the disclosed imaging capture and video display system.

FIG. 2 illustrates a more detailed view of the disclosed imaging capture and video display system.

FIG. 3 illustrates a flow diagram for streaming a digital video data stream using the disclosed imaging capture and video display system.

FIG. 4 illustrates an example voice activation flow diagram for zooming a camera and accessing a software for playing and stopping access to video streams and switching to different views, such as patient vital signs.

FIG. 5 is a block diagram of a streaming hardware system in accordance with the present disclosure.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

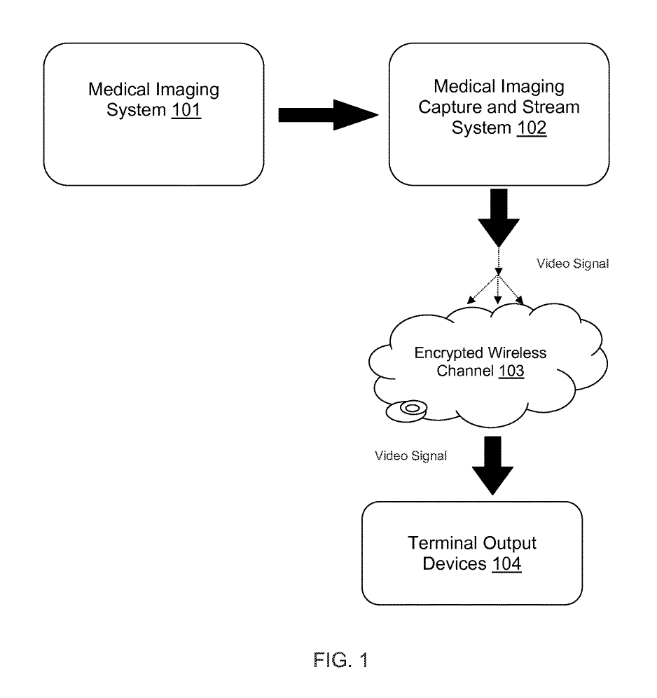

The disclosed system may include, as seen in FIG. 1, a medical imaging system (e.g., MRI system, CT system, endoscopic or laparoscopic devices, etc.) 101, a medical imaging capture and video stream system or apparatus 102, one or more computing devices (e.g., client or server computers, possibly including a streaming and/or additional software) and/or one or more terminal output/display devices (e.g., display screens, computer monitors, mobile devices such as tablets or smart phones, or wearable electronic mobile devices such as smart display glasses, such as available from Google) 104 may be communicatively coupled via a wired or wireless network, described below, possibly transmitting data via one or more encrypted wireless channels 103. The medical imaging system 101 may generate imaging data. The imaging data may be transmitted via the network to the medical imaging capture and video stream system 102, encoded into a digital video data stream using a streaming software on one or more computing devices, and transmitted, through the network via the encrypted wireless channel(s), 103 to the terminal output/display device(s) 104.

In the healthcare application, compliance to industry standards such as the Health Insurance Portability and Accountability Act (HIPAA) are achieved through the security protocols employed by the streaming system. All personally identifiable health information (PHI) is removed from the data before it is transmitted wirelessly. All data packets are transmitted on an authorized channel and encrypted using AES 256 bit encryption.

The terminal output/display device(s) 104 may include a mounted camera with a lens transmitting a view of a surgical field. A display attached to the terminal output/display device(s) 104 may display the encrypted video data stream concurrently with the view of the surgical field. In some embodiments, the medical imaging data and/or the digital video data stream may be displayed on one or more additional terminal output/display devices and/or display screens, such as desktop or laptop computers, or mobile devices such as cell phones, tablets or smart display glasses.

The medical imaging capture and video stream system 102, and/or one or more terminal output/display devices 104 may include an operating system for accessing, running and/or executing one or more software applications, described below, to be used in conjunction with the medical imaging capture and video stream system 102 described above.

For example, in some embodiments, the terminal output device 104 may comprise smart display glasses, which may include a high resolution camera. The camera may zoom in and out of the surgical field, auto-focusing on the surgical field during each zoom, to give the surgeon greater orientation via better depth perception and a broader field of view. The apps accessible to the surgeon via the computing device or terminal output display device(s) 104 may also allow the surgeon to access medical data from additional software applications, possibly including navigation software, thereby transforming the smart display glasses into both a display device and a navigation tool, in which the current surgical field may be displayed side-by-side with navigation or other surgical data in real time. Other example applications may include video recording/streaming and/or transcription software for teaching or collaborative endeavors, etc. The surgeon may also access patient data records, research studies and/or current vital signs during the operation.

The medical imaging capture and video stream system 102, and/or one or more terminal output/display devices 104 may include a voice command system. For example, this voice command system may allow a surgeon, using preset vocal commands, and without manual input, to: zoom the camera view in and out to give the surgeon a wider field of view with better depth perception; access and display data from navigation software; begin recording and/or transcribing commentary during a procedure; access and display patient history data or current vital signs, research study data, etc. The recording and/or transcription may be wirelessly transmitted and stored on the computing device or other storage.

In embodiments where the terminal output/display device 104 is a pair of smart display glasses, the goggles may comprise a radio protective device made of radio protective material, thereby including all of the benefits of a wearable smart device (e.g., hands-free voice commands to apps and patient/medical record data, microscope-free viewing, etc.), while also acting as protective goggles from radiation from x-rays or other radiological equipment, bodily fluids during surgery, etc.

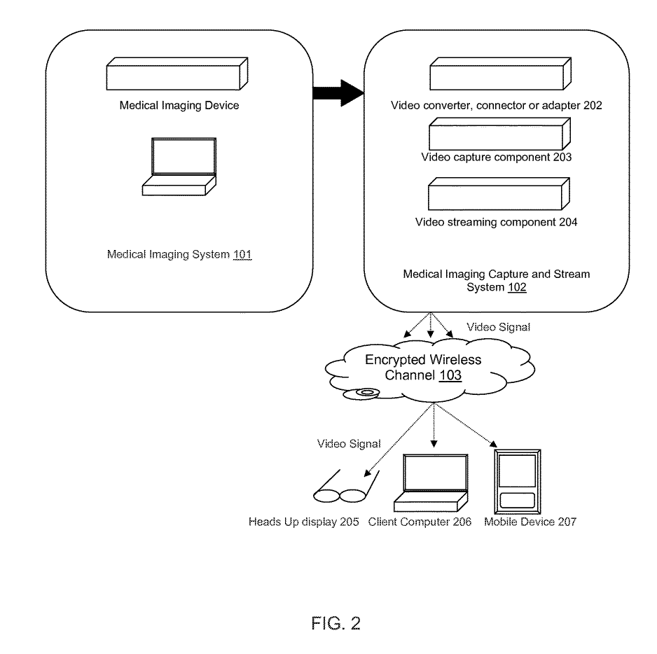

Returning to FIGS. 1-2, the disclosed system may comprise a medical imaging system 101, a medical imaging capture and video stream system 102, one or more computing devices, and/or one or more terminal output/display devices 205-207. The medical imaging system (e.g., MRI system, CT system, endoscopic or laparoscopic devices, etc.) 101, the medical imaging capture and video stream system or apparatus 102, one or more computing devices (e.g., client or server computers, possibly including a streaming and/or additional software) and/or one or more terminal output/display devices (e.g., display screens, computer monitors, mobile devices such as tablets or smart phones, or wearable electronic mobile devices such as smart display glasses) 104 may be communicatively coupled via a wired or wireless network, possibly transmitting data via one or more encrypted wireless channels 103.

Any of the hardware devices within the disclosed system may also be smart devices, meaning that they are able to store and run software applications. Thus, each of the disclosed hardware devices may comprise any combination of display monitors, computer monitors, desktop computers, laptop computers, mobile devices such as tablets or smart phones, or wearable smart devices such as smart display glasses. Any of these hardware devices may include their own processors, operating system and/or software modules/instructions, which may work independently or in conjunction with any additional hardware or software to execute any of the instructions and disclosed method steps as outlined herein.

The system components listed above, as well as any subcomponents listed herein, may be communicatively coupled via a wired or wireless network, possibly including software or firmware components allowing transmissions throughout the network, which may be encrypted, as described below. For example, the medical imaging system 101 may run software, which a user may utilize to process the imaging data generated from the medical imaging system 101. In this example, the medical imaging system 101 and the imaging capture and video stream system 102 may each comprise video connectors, converters and/or adapters acting as coupling means. These coupling means may include, as non-limiting examples, HDMI, VGA, DVI or USB input and output ports. These ports may act as a channel for relaying digital imaging and/or video signals, allowing the various components of the disclosed system to transfer data via wired couplings. In this example, the medical imaging system 101 may transfer imaging data to the imaging capture and video stream system 102 using the coupling means, data relaying means and/or video connectors, converters and/or adapters described above.

In some embodiments, the imaging and streaming video data may be relayed over an encrypted wireless channel 103 of a wireless network. For example, the heads-up display 205, computer 206 and/or smart phone 207 may require wireless connectivity via a wireless network using, for example, wireless 8011 B, G or N network protocols in order to receive digital video signals from the encrypted wireless channel 103 in such a wireless network.

In some embodiments, the data transmitted over the network may comprise encrypted data. In some embodiments, this encryption may occur prior to the data being sent through the network. For example, data may be encrypted using a WPA (WiFi Protected Access) protocol. In either case, all personally identifiable health information may be stripped from the data prior to transmission over the network. Thus, the system will be compliant with current Health Insurance Portability and Accountability Act (HIPAA) policies, as personally identifiable health information will never be transmitted over the network.

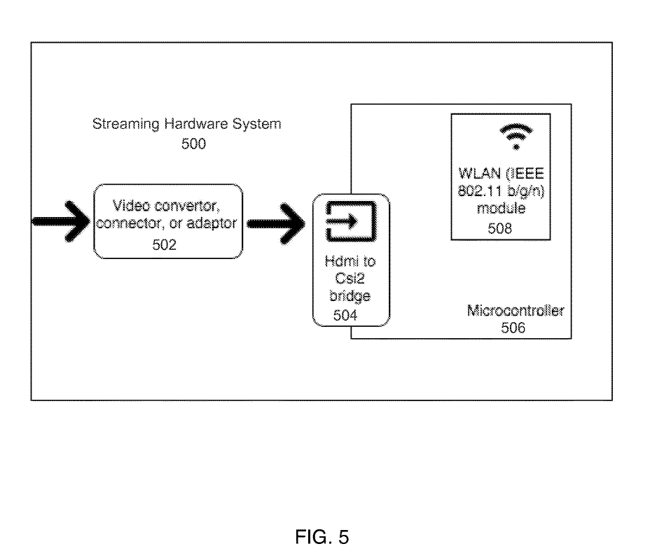

For example, referring to FIG. 5 a block diagram of a streaming hardware system 500 is provided. The streaming hardware system includes a video converter, connector, or adapter 502 configured to receive video from a source and provide it to, for example, an HDMI to CSI2 bridge 504, such as a TC358743XBG bridge, which uses a Toshiba integrated circuit. The chip supports for the HDMI input of the bridge 504, and converts the video stream into MIPI CSI-2 transmission. A gstreamer plugin imxv4l2src may be configured to run on a microcontroller 506 to operate as a CSI video source. The video source can be encoded or transmitted raw into an RTP payload. The RTP payload may be broadcast to an IP port on a local network created by a WLAN module 508. Using the network manager in the Linux os on the microcontroller, a WPS2 with AES encryption network can be created.

HIPAA regulates that data at rest and in transmission is encrypted and protected through authorization. In this configuration, when the device is off, there is no data stored at rest and no data is being transmitted. When the device is turned on, only users with credentials to login to the wireless network are able to see the networks traffic. Packets on the encrypted network use AES 256 bit encryption for every packet.

Returning to FIGS. 1-2, the medical imaging system 101 may generate imaging data. The components of the medical imaging system 101 may comprise any known medical imaging system components currently used within an operating room during surgical procedures. For example, the medical imaging system 101 may include MRI systems, CT systems, endoscopic or laparoscopic devices, navigation systems, or the like. In some embodiments, the medical imaging system 101 may project the generated imaging data directly onto one or more terminal output/display devices 104, possibly including one or more medical imaging monitors used in operating rooms during intra-operative surgical procedures.

In some embodiments, the video connector, converter or adapter acquires digital signals from the medical imaging monitor, then may relay the signal a video capture component of the imaging capture and video stream system 102. The video capture component may in turn, read in the video signal from the medical imaging device 101 and transmit the signal onto the medical imaging monitors, while also transmitting a digital video data stream onto encrypted wireless channel 103, as described below.

The imaging data may be transmitted via the network to the medical imaging capture and video stream system 102, encode it into a digital video data stream using a streaming software on one or more computing devices, and transmit it, through the network via the encrypted wireless channel(s), 103 to the terminal output/display device(s) 104. In some embodiments, the hardware components of the medical imaging system 101 and/or the medical imaging capture and stream system 102 may be housed within a high-strength plastic or metal casing, designed with sufficient width, length and breadth to house all necessary hardware subcomponents. For example, such a case may be 15 to 20 inches deep and 15 to 20 inches wide. The imaging capture and video stream system 102 may also include software for capturing digital information and streaming it, as described below.

The medical imaging capture and video stream system 102 may therefore include a video connector, converter or adapter 202, the video capture component 203, and the video streaming component 204. The video connector, converter, or adapter was described in detail above. The video capture component 203 may read in a video signal from the medical imaging device 101, register and process the video signal and transmit the signal onto medical monitors connected directly to the video capture component 203. In other embodiments, the video capture component 203 may read in a video signal from the medical imaging device 101, process the video signal, and relay the signal to the video streaming component 204 to be streamed over wireless channel 103, described in more detail below. However, in any embodiment, the video displayed on the terminal output device 205-207 may be displayed in real time, meaning the imaging data may be displayed on the terminal output device(s) 205-207 at the same time it is being read from the medical imaging system.

The video streaming component 204 may comprise software that streams the captured digital video data from the video capture component 203, onto the encrypted wireless channel 103. The video streaming component 204 may therefore include software instructions for encrypting the digital video data stream, either on the hardware running the video streaming component, or within a router over which the digital video data stream is transmitted via the encrypted wireless channel 103.

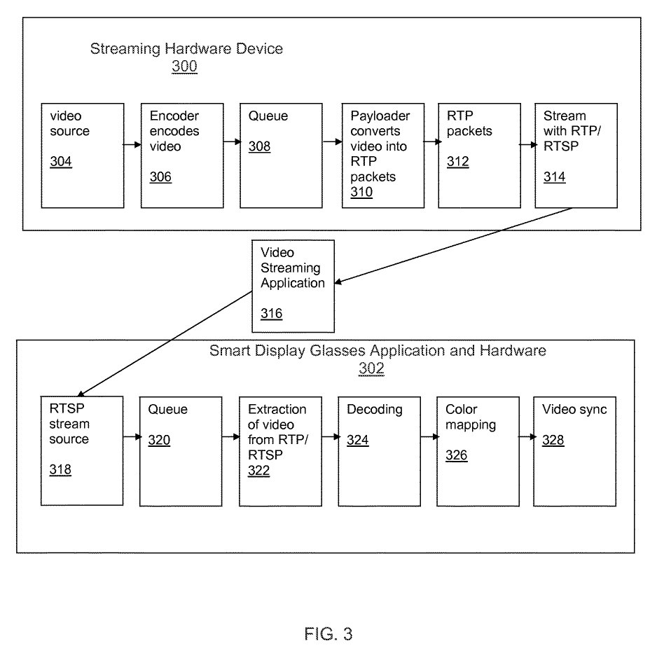

FIG. 3 is flow chart setting forth an example of steps data processing for a streaming hardware device 300 to communicate with application and hardware of smart display glasses 302. The process begins at process block 304 with the receipt of a raw video source, which, as a non-limiting example, may be analog video source. The video source is passed to an encoder that encodes the video at process block 306 and proves it to a queue at process block 308. At process block 310, pay loader instructions within the software may convert the video into Real Time Transfer Protocol (RTP) packets at process block 312, which may be streamed using RTP or Real Time Streaming Protocol (RTSP) at process block 314, as non-limiting examples. The packets may be streamed using a video streaming application 316 to the terminal output devices 205-207 of FIG. 2. In FIG. the terminal output devices will be referred to as the non-limiting example of a smart display glasses (hardware and software) 302. The terminal output devices may include, as non-limiting examples, a wearable heads-up display, such as smart display glasses 205 (possibly used by a clinician during a surgical procedure), any desktop or laptop computer 206 or a smart phone 207.

The smart display glasses 302 of FIG. 3 may include a high definition camera configured to zoom and focus, potentially replacing microscopes in the operating room. Again, in any embodiment, the video displayed on the terminal output device 205-207 may be displayed in real time, meaning the imaging data may be displayed on the terminal output device(s) 205-207 at the same time it is being read from the medical imaging system. For example, at process block 318, the RTSP stream source is received and provided to the queue at process block 320. At process block 322, an extraction may be performed. As a non-limiting example, the extraction may use a codec, such as H.264. Regardless of the particular codec, at process block 324, decoding may be performed, followed by color mapping at process block 326, and video synchronization at process block 328.

As noted above, any of the disclosed devices may be smart devices, meaning that each may include one or more processors, operating systems and/or software allowing a user to load or create software to be run on the device. This software may be used to improve the medical applications of the disclosed system. For example, In addition to the described smart display glasses acting as a “mobile microscope,” the system can be used as smart technology integrating different software applications onto this smart mobile device.

As a non-limiting example, the disclosed devices, and particularly computers or smart display glasses used as terminal output devices, may be configured to store and run (or access via cloud computing) currently available navigation systems using pre-operative MRI and CT data to orient a surgeon within the surgical field. This data may be transferred to the displays (e.g., smart display glasses), thereby allowing a surgeon to load, display or otherwise integrate pre-op MRI images with the real-time operating room images to be displayed on the display screen. For example, if a surgeon were to be looking at a lesion in vivo, live images on the display device could be correlated with pre-op imaging on axial, saggital and/or coronal planes. The focal point of these images and data may be displayed by the high resolution camera described above, thereby serving as a probe. The resulting stereotactic data may be used to display pre-op images side by side so that the surgeon knows exactly where they are in the surgical field.

Other software applications may include recording videos and dialog, which can be stored on the device or into a cloud environment. The software may also transform the smart device into a dictation device to capture doctors' oral observations during surgery. The software may also access a database of patient data or electronic health records or publications in order to access patient data such as vitals, research data, imaging, patient notes, relevant publications, etc.

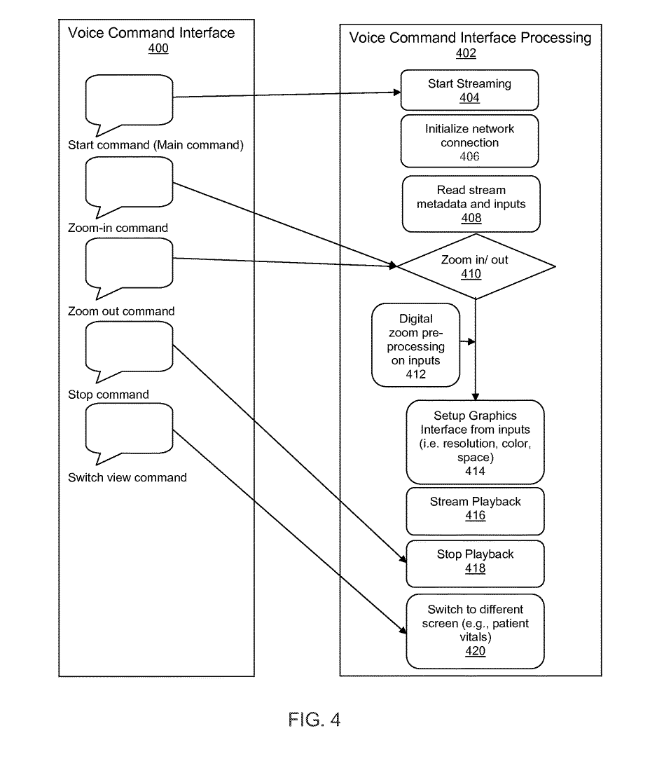

Any of this software may be accessible via voice activation. Voice activation software may be used to access images or any other software functions described above while the surgeon is operating, thereby freeing the surgeon's hands to stay within the surgical field, rather than access necessary mouse clicks or keyboard commands. In some embodiments, the software applications and/or relevant data may be displayed within the smart display glass in the surgeon's field of view. As one non-limiting example, referring to FIG. 4, a voice command interface 400 may be provided that triggers various operations by a voice command interface processing system 402. For example, the voice command interface 400 may be configured to monitor for a list of predetermined key phrases, including “start” or “begin”, “zoom in”, “zoom out,” “stop”, and “switch view,” to provide just a few examples. A non-limiting flow chart is provided with the voice command interface processing system 402 to illustrate just one of the many, many workflows that could be performed using these few exemplary commands. For example, the “start” command, may be used in this non-limiting workflow to begin streaming at process block 404. Based thereon, the network connection may be initialized at process block 406 and the stream metadata and inputs are read at process block 408.

Further in this non-limiting example of how the voice activation may be used to control activating the software, zooming the camera may be controlled with the “zoom in” and “zoom out” commands that cause the software to operate accordingly at process block 410, 412, and 414, while maintaining streaming playback at 416. That is, in response to a “zoom in” or “zoom out” command, digital zoom pre-processing on inputs 412 may be coordinated with the zoom level and setup graphics interface from the appropriate inputs are managed 414, such that proper streaming playback is provided 416.

A “stop” or “switch view” command can be used to discontinue the playback at process block 418 or switch to a different screen at process block 420, such as from images to patient vitals. Thus, even with just these examples of the many voice commands that can be used, one can access the software in order to play and stop access to video streams, switch to different screens, such as patient vital signs, and perform many other operations.

Given the popularity of “telemedicine,” in research and educational medical fields, the disclosed system and software may record videos of the surgical procedure, which may be transmitted via the Internet or any other network to other physicians who are also using the system (e.g., utilizing smart display glasses). Similarly, the physician user may also share other patient data, such as vital signs, their most recent progress notes, imaging studies, lab studies and any other data stored within data storage. This data may be transmitted to the other user's terminal output device (e.g., smart display glasses), which may be recalled through voice activation. Similarly, videos and photos taken during the surgery may also be used as educational tools for teaching trainees.

In embodiments including smart display glasses, the glasses may be used as a radio-protective device so that when x-rays are used in the operating room, the surgeon's eyes are protected. For example, surgeons may rely on intra-operative x-ray to localize lesions and may therefore require a separate pair of radio-protective glasses. In embodiments where the smart display glasses are made from a radio-protective material, the surgeon could use only the disclosed smart display glasses, thereby eliminating the need for separate radio protective glasses, as well as surgical loupes and/or microscopes.

The steps included in the embodiments illustrated and described in relation to FIGS. 1-4 are not limited to the embodiment shown and may be combined in several different orders and modified within multiple other embodiments. Although disclosed in specific combinations within these figures, the steps disclosed may be independent, arranged and combined in any order and/or dependent on any other steps or combinations of steps.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A system, comprising:
a magnetic resonance imaging (MRI), computerized tomography (CT), endoscopic, or laparoscopic device generating a medical imaging data during a surgical procedure;
at least one processor executing instructions on a computing device coupled to a network, the instructions causing the computing device to:
receive the medical imaging data from the MRI, CT, endoscopic, or laparoscopic device;
encode a digital video data stream from the medical imaging data;
encrypt the digital video data stream for wireless transmission;
transmit an encrypted video data stream via an encrypted wireless channel; and
a display glasses device coupled to the network and comprising:
a camera mounted to the display glasses device comprising a lens transmitting, to the display glasses device, a view of a surgical field;
a display attached to the display glasses device and displaying the encrypted video data stream concurrently with the view of the surgical field.

2. The system of claim 1, further comprising at least one display screen proximate to the display glasses device, wherein:
the medical imaging device transmits the medical imaging data directly to the at least one display screen; or
the computing device transmits the encrypted video data stream to the at least one display screen.

3. The system of claim 1, wherein the network comprises:
a wireless network comprising a wireless network router configured to:
encrypt the digital video data stream; and
transmit the encrypted video data stream via the encrypted wireless channel; or
a video connector, converter or adapter comprising at least one HDMI, VGA, DVI, or USB port connecting the medical imaging device, the computing device or the wireless router for data input and output.

4. The system of claim 1, wherein the instructions cause the display glasses device or the computing device to:
query a database coupled to the network to retrieve at least one navigable imaging data generated prior to the surgical procedure;
display the at least one navigable imaging data on the display glasses device;
zoom and focus the camera within the surgical field;
record the surgical field during the surgical procedure; or
transmit the view of the surgical field to an additional display glasses device.

5. The system of claim 4, wherein the instructions are executed in response to a voice command received by the display glasses device or the computing device.

6. The system of claim 1, wherein the display glasses device comprising:
radio protective goggles comprising a radio protective material displaying the encrypted video data stream and the view of the surgical field; and
arms to mount the display glasses bringing the display glasses into a field of view of a user.

7. A system, comprising:
at least one processor executing instructions on an imaging capture and video streaming apparatus coupled to a network, the instructions causing the imaging capture and video streaming apparatus to:
receive an imaging data from a medical imaging device;
encode a digital video data stream from the video data;
transmit the digital video data stream via a wireless channel to at least one terminal output device coupled to the network, the terminal output device comprising:
a camera mounted to the terminal output device comprising a lens transmitting, to the terminal output device, a view of a surgical field;
a display attached to the terminal output device; and
displaying the digital video data stream concurrently with the view of the surgical field.

8. The system of claim 7, wherein the at least one terminal output device comprises:
a display glasses device comprising a heads-up display; or
at least one display screen;
wherein the medical imaging device transmits the imaging data directly to the terminal output device; or
the imaging capture and video streaming apparatus transmits the digital video data stream to the at least one terminal output device.

9. The system of claim 7, wherein the instructions cause the imaging capture and video streaming apparatus to:
encrypt the digital video data stream; and
transmit an encrypted digital video data stream via an encrypted wireless channel.

10. The system of claim 7, wherein the network comprises:
a wireless network comprising a wireless router configured to:
wirelessly encrypt the digital video data stream; and
transmit an encrypted digital video data stream via an encrypted wireless channel; or
a video connector, converter or adapter comprising at least one HDMI, VGA, DVI or USB port connecting the medical imaging device, the imaging capture and video streaming apparatus or the wireless router for data input and output.

11. The system of claim 7, wherein the instructions cause the at least one terminal output device or the imaging capture and video streaming apparatus to:
query a database coupled to the network to retrieve at least one navigable imaging data;
display the at least one navigable imaging data on the terminal output device;
zoom and focus the camera within the surgical field;
record the surgical field during a surgical procedure; or
transmit the view of the surgical field to an additional terminal output device.

12. The system of claim 11, wherein the instructions are executed in response to a voice command by a user of the imaging capture and video streaming apparatus.

13. The system of claim 7, wherein the at least one terminal output device comprises a display glasses device, the display glasses device comprising:
radio protective goggles comprising a radio protective material displaying the digital video data stream and the view of the surgical field; and
arms to mount the display glasses bringing the display glasses into a field of view of a user.

14. A method, comprising the steps of:
receiving, by an imaging capture and video streaming apparatus coupled to a network, an imaging data from a medical imaging device;
encoding, by the imaging capture and video streaming apparatus, a digital video data stream from the imaging data;
transmitting, by the imaging capture and video streaming apparatus, the digital video data stream via a wireless channel, to at least one terminal output device coupled to the network, the terminal output device comprising:
a camera mounted to the terminal output device comprising a lens transmitting, to the terminal output device, a view of a surgical field;
a display attached to the terminal output device and displaying the digital video data stream concurrently with the view of the surgical field.

15. The method of claim 14, further comprising the steps of:
transmitting, by the medical imaging device, the imaging data directly to the terminal output device; or
transmitting, by the imaging capture and video streaming apparatus, the digital video data stream to the at least one terminal output device;
wherein the at least one terminal output device comprises:
a display glasses device comprising a heads-up display; or,
at least one display screen.

16. The method of claim 14, further comprising the steps of:
encrypting, by the imaging capture and video streaming apparatus, the digital video data stream; and
transmitting, by the imaging capture and video streaming apparatus, the encrypted digital video data stream via an encrypted wireless channel.

17. The method of claim 14, wherein the network comprises:
a wireless network comprising a wireless router configured to:
wirelessly encrypt the digital video data stream; and
transmit an encrypted digital video data stream via an encrypted wireless channel; or
a video connector, converter or adapter comprising at least one HDMI, VGA, DVI or USB port connecting the medical imaging device, the imaging capture and video streaming apparatus or the wireless router for data input and output.

18. The method of claim 14, further comprising the steps of:
querying a database coupled to the network to retrieve at least one navigable imaging data;
displaying the at least one navigable imaging data on the terminal output device;
zooming and focusing the camera within the surgical field;
recording the surgical field during a surgical procedure; or
transmitting the view of the surgical field to an additional terminal output device.

19. The method of claim 18, wherein the querying, displaying, zooming and focusing, recording, and transmitting steps are executed in response to a voice command by a user of the imaging capture and video streaming apparatus.

20. The method of claim 14, wherein the at least one terminal output device comprises a display glasses device, the display glasses device comprising:
radio protective goggles comprising a radio protective material displaying the digital video data stream and the view of the surgical field; and
arms to mount the display glasses bringing the display glasses into a field of view of a user.
